(19) United States
(12) Patent Application Publication
(10) Pub. No.: US 2021/0116086 A1
(43) Pub. Date: Apr. 22, 2021

(54) LIGHTING APPARATUS

(71) Applicant: XIAMEN LEEDARSON LIGHTING CO.,LTD, Xiamen (CN)

(72) Inventors: Wenjin Peng, Xiamen (CN); Xiaoliang Wen, Xiamen (CN); Shouqiang Hou, Xiamen (CN)

(21) Appl. No.: 17/072,827

(22) Filed: Oct. 16, 2020

(30) Foreign Application Priority Data
Oct. 16, 2019 (CN) 201921737433.X

(51) Int. Cl. F21S 8/04; F21V 17/16; F21V 23/00; F21V 5/00; F21V 7/04; F21V 23/06; F21V 23/04

(52) U.S. Cl. CPC F21S 8/04; F21V 17/16; F21V 23/005; F21V 5/007; F21Y 2115/10; F21V 7/04; F21V 23/06; F21V 23/0442; F21V 23/002

(57) ABSTRACT

A lighting apparatus includes a light passing cover, a base disk, multiple hooks, a light source module and a driver module. The light passing cover has an exterior side and an inner side. The inner side has multiple sliding grooves. The base disk has a central part and a curved wall. Each hook has a fixed end and a reverse hook. The fixed end is fixed to the base disk. The reverse hook is inserted to the sidling groove to fix the light passing cover to the base disk. The light source module is mounted on the base disk. The light source module includes multiple LED strips. The driver module is disposed at a center of the base disk. The driver module is surrounded by the multiple LED strips. The LED strips includes multiple LED modules.

### FIELD

The present invention is related to a lighting apparatus, and more particularly related to a lighting apparatus with optical parameter adjustment.

### BACKGROUND

The time when the darkness is being lighten up by the light, human have noticed the need of lighting up this planet. Light has become one of the necessities we live with through the day and the night. During the darkness after sunset, there is no natural light, and human have been finding ways to light up the darkness with artificial light. From a torch, candles to the light we have nowadays, the use of light have been changed through decades and the development of lighting continues on.

Early human found the control of fire which is a turning point of the human history. Fire provides light to bright up the darkness that have allowed human activities to continue into the darker and colder hour of the hour after sunset. Fire gives human beings the first form of light and heat to cook food, make tools, have heat to live through cold winter and lighting to see in the dark.

Lighting is now not to be limited just for providing the light we need, but it is also for setting up the mood and atmosphere being created for an area. Proper lighting for an area needs a good combination of daylight conditions and artificial lights. There are many ways to improve lighting in a better cost and energy saving. LED lighting, a solid-state lamp that uses light-emitting diodes as the source of light, is a solution when it comes to energy-efficient lighting. LED lighting provides lower cost, energy saving and longer life span.

The major use of the light emitting diodes is for illumination. The light emitting diodes is recently used in light bulb, light strip or light tube for a longer lifetime and a lower energy consumption of the light. The light emitting diodes shows a new type of illumination which brings more convenience to our lives. Nowadays, light emitting diode light may be often seen in the market with various forms and affordable prices.

After the invention of LEDs, the neon indicator and incandescent lamps are gradually replaced. However, the cost of initial commercial LEDs was extremely high, making them rare to be applied for practical use. Also, LEDs only illuminated red light at early stage. The brightness of the light only could be used as indicator for it was too dark to illuminate an area. Unlike modern LEDs which are bound in transparent plastic cases, LEDs in early stage were packed in metal cases.

In 1878, Thomas Edison tried to make a usable light bulb after experimenting different materials. In November 1879, Edison filed a patent for an electric lamp with a carbon filament and keep testing to find the perfect filament for his light bulb. The highest melting point of any chemical element, tungsten, was known by Edison to be an excellent material for light bulb filaments, but the machinery needed to produce super-fine tungsten wire was not available in the late 19th century. Tungsten is still the primary material used in incandescent bulb filaments today.

Early candles were made in China in about 200 BC from whale fat and rice paper wick. They were made from other materials through time, like tallow, spermaceti, colza oil and beeswax until the discovery of paraffin wax which made production of candles cheap and affordable to everyone. Wick was also improved over time that made from paper, cotton, hemp and flax with different times and ways of burning. Although not a major light source now, candles are still here as decorative items and a light source in emergency situations. They are used for celebrations such as birthdays, religious rituals, for making atmosphere and as a decor.

Illumination has been improved throughout the times. Even now, the lighting device we used today are still being improved. From the illumination of the sun to the time when human can control fire for providing illumination which changed human history, we have been improving the lighting source for a better efficiency and sense. From the invention of candle, gas lamp, electric carbon arc lamp, kerosene lamp, light bulb, fluorescent lamp to LED lamp, the improvement of illumination shows the necessity of light in human lives.

There are various types of lighting apparatuses. When cost and light efficiency of LED have shown great effect compared with traditional lighting devices, people look for even better light output. It is important to recognize factors that can bring more satisfaction and light quality and flexibility.

It is important to provide a convenient assembly design for lighting devices, particularly when some lighting devices need to be installed to a ceiling.

Flexibility and multi-function are also important and beneficial during design process.

### SUMMARY

In some embodiments, a lighting apparatus includes a light passing cover, a base disk, multiple hooks, a light source module and a driver module.

The light passing cover has an exterior side and an inner side. Specifically, in some embodiments, there is an inverse edge at a peripheral end of the light passing cover. The inverse edge has an inwardly extending structure facing to center of the light passing cover. In some embodiments, the light passing cover is a circular shape structure.

The inner side has multiple sliding grooves. When there is the inverse edge mentioned above, the inner side is facing downwardly to the base disk.

The base disk has a curvature facing upwardly to the light passing cover.

The base disk has a central part and a curved wall.

Each hook has a fixed end and a reverse hook. The fixed end is fixed to the base disk. The reverse hook is inserted to the sidling groove to fix the light passing cover to the base disk.

The light source module mounted on the base disk.

The light source module includes multiple LED strips.

The driver module is disposed at a center of the base disk.

The driver module is surrounded by the multiple LED strips.

The LED strips includes multiple LED modules.

Each LED module has a diffusion lens disposed on a LED chip for diffusing a light of the LED chip.

Such diffusion lens helps distribute light of the LED modules to the light passing cover forming a surface illuminance light source.

In some embodiments, the central part of the base disk has a concave area with fixing holes for fixing to an installation unit. Specifically, the concave area has a larger distance to the light passing cover than adjacent areas on the base disk.

An external wire is passes through the concave area connected to the driver module. The base disk is fixed to an installation platform like a ceiling. There may be a bracket to fix the base disk with screws or rotation fixing structures. Power wires connected to a 110V/220V alternating current power source is connected to the driver module. The bracket may have an electrode and a plugging structure for electrically connecting and routing the external power to the driver module of the lighting apparatus.

In some embodiments, the central part has a surrounding ring surrounding the concave area. The surrounding has a depth with respect to the concave area.

The LED strips are fixed on the surrounding ring.

In some embodiments, the curve wall has a reflective layer facing to the LED module.

In some embodiments, the driver module has multiple sockets for electrically connected to the multiple LED strips.

In some embodiments, the driver module has an insulation box preventing electricity contact of a driver circuit from users.

In some embodiments, a reflective layer is attached on an exterior surface of the insulation box.

In some embodiments, the LED strip has an electrode end to be detachably plugged into the socket of the driver module.

In some embodiments, the driver module automatically adjusts a control mode depending on a number of inserted LED strips.

In some embodiments, the electrode end has a type structure for indicating the driver module which type of the inserted LED strip.

In some embodiments, the LED strip has a conductive part covered by an insulation layer.

In some embodiments, the light passing cover has an escape part at an entrance of the sliding groove for the reverse hook to slide into the sliding groove.

In some embodiments, the driver module is detachably plugged to a plugging terminal disposed on the central part of the base disk.

Users select a required type of the driver module to be plugged to the plugging terminal.

In some embodiments, the plugging terminal is electrically connected to an external power source.

In some embodiments, an antenna is fixed to a top surface of the driver module facing to the light passing cover.

In some embodiments, a top cover of the driver module facing to the light passing cover emits a second light.

In some embodiments, a switch is used for a user to adjust intensity of the second light to be consistent with a first light of the light source appearing on the light passing cover.

In some embodiments, the LED strips are mounted with red, green, blue LED modules and two white LED modules with different color temperatures.

In some embodiments, the red, green, blue LED modules are located at central areas surrounded by a portion of the white LED modules.

In some embodiments, the driver module has an ambient sensor for detecting an ambient color temperature when the LED strips are turned off and control the LED strips to mix a required mixed color temperature based on the ambient color temperature.

### BRIEF DESCRIPTION OF DRAWINGS

FIG. 1 illustrates an exploded view of a lighting apparatus embodiment.

FIG. 2 illustrates a side view of components in the example in FIG. 1.

FIG. 3 illustrates a light passing cover example.

FIG. 4 illustrates a hook example.

FIG. 5 shows a lighting apparatus embodiment.

FIG. 6 shows a side view illustrating relations among components.

FIG. 7 shows a LED module arrangement.

### DETAILED DESCRIPTION

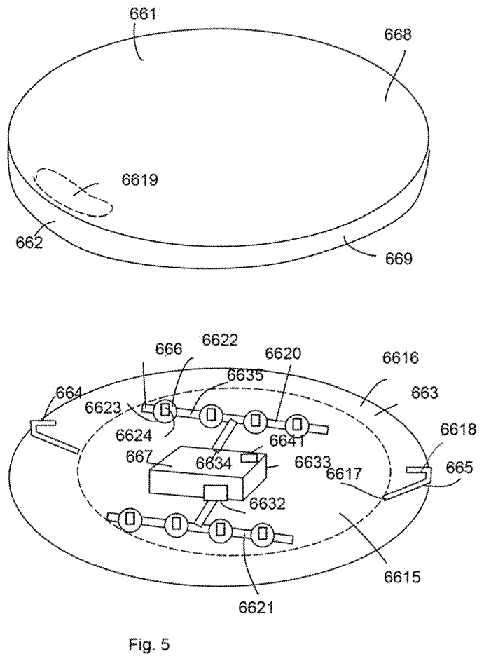

In FIG. 5, a lighting apparatus includes a light passing cover 661, a base disk 663, multiple hooks 664, 665, a light source module 666 and a driver module 667.

The light passing cover 661 has an exterior side 668 and an inner side 669.

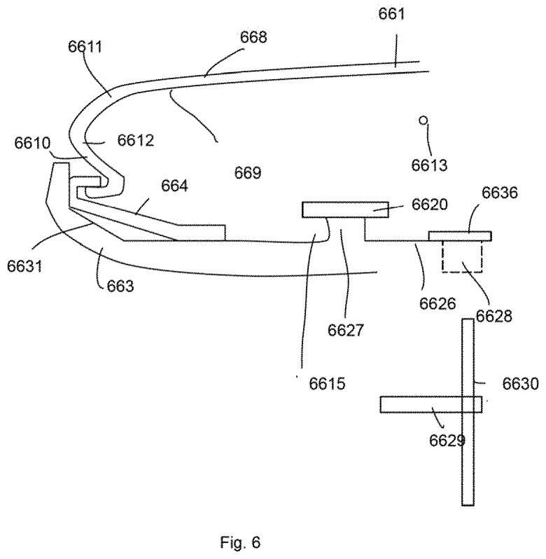

FIG. 6 shows a side view diagram showing relations of the components. In the following disclosure, the same reference numerals in the drawings refer to the same components and are not repeated for brevity.

In FIG. 6, there is an inverse edge 6610 at a peripheral end 6611 of the light passing cover 661. The inverse edge 6611 has an inwardly extending structure 6612 facing to center 6613 of the light passing cover 661.

In some embodiments, the light passing cover is a circular shape structure.

The inner side 669 has multiple sliding grooves. When there is the inverse edge mentioned above, the inner side is facing downwardly to the base disk.

For example, FIG. 3 shows a sliding groove 8 for inserting the hook 5 in FIG. 4.

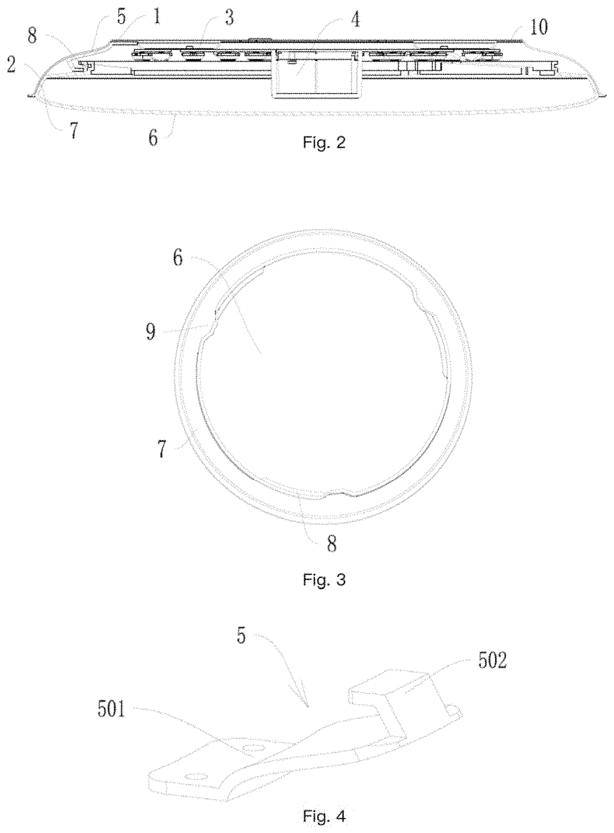

The base disk has a curvature facing upwardly to the light passing cover, as illustrated in FIG. 6 and FIG. 2.

In FIG. 5, the base disk 663 has a central part 6615 and a curved wall 6616.

Each hook 665 has a fixed end 6617 and a reverse hook 6618. The fixed end 6617 is fixed to the base disk 663. The reverse hook 6618 is inserted to the sidling groove 6619 to fix the light passing cover 661 to the base disk 663.

The light source module 666 is mounted on the base disk 663.

The light source module 666 includes multiple LED strips 6620, 6621.

The driver module 667 is disposed at a center of the base disk 663.

The driver module 667 is surrounded by the multiple LED strips 6620, 6621.

The LED strips 6620 includes multiple LED modules 6622.

Each LED module 6622 has a diffusion lens 6623 disposed on a LED chip 6624 for diffusing a light of the LED chip 6624.

Such diffusion lens helps distribute light of the LED modules to the light passing cover forming a surface illuminance light source.

In FIG. 6, the central part 6615 of the base disk has a concave area 6626 with fixing holes 6628 for fixing to an installation unit 6629. Specifically, the concave area 6628 has a larger distance to the light passing cover than adjacent areas on the base disk.

An external wire 6630 is passed through the concave area connected to the driver module. The base disk is fixed to an installation platform like a ceiling. There may be a bracket to fix the base disk with screws or rotation fixing structures. Power wires connected to a 110V/220V alternating current power source is connected to the driver module. The bracket may have an electrode and a plugging structure for electrically connecting and routing the external power to the driver module of the lighting apparatus.

In some embodiments, the central part has a surrounding ring 6627 surrounding the concave area 6626. The surrounding ring 6627 has a depth with respect to the concave area 6626.

The LED strips 6620 are fixed on the surrounding ring 6627.

In some embodiments, the curve wall has a reflective layer 6631 facing to the LED module.

In FIG. 5, the driver module 667 has multiple sockets 6632 for electrically connected to the multiple LED strips 6621.

In some embodiments, the driver module has an insulation box 6633 preventing electricity contact of a driver circuit from users.

In some embodiments, a reflective layer is attached on an exterior surface of the insulation box 6633.

In some embodiments, the LED strip 6620 has an electrode end 6634 to be detachably plugged into the socket of the driver module 667.

In some embodiments, the driver module automatically adjusts a control mode depending on a number of inserted LED strips.

In some embodiments, the electrode end has a type structure for indicating the driver module which type of the inserted LED strip.

In some embodiments, the LED strip has a conductive part covered by an insulation layer 6635. The insulation layer wraps conductive par to the LED strip.

In FIG. 3, the light passing cover has an escape part 9 at an entrance of the sliding groove 8 for the reverse hook 5 in FIG. 4 to slide into the sliding groove 8.

In some embodiments, the driver module is detachably plugged to a plugging terminal 6636 disposed on the central part 6615 of the base disk 661.

Users select a required type of the driver module to be plugged to the plugging terminal.

In some embodiments, the plugging terminal is electrically connected to an external power source.

In FIG. 5, an antenna 6641 is fixed to a top surface of the driver module 667 facing to the light passing cover 661.

In some embodiments, a top cover of the driver module facing to the light passing cover emits a second light.

In some embodiments, a switch is used for a user to adjust intensity of the second light to be consistent with a first light of the light source appearing on the light passing cover.

In some embodiments, the LED strips are mounted with red, green, blue LED modules and two white LED modules with different color temperatures.

In some embodiments, the red, green, blue LED modules are located at central areas surrounded by a portion of the white LED modules.

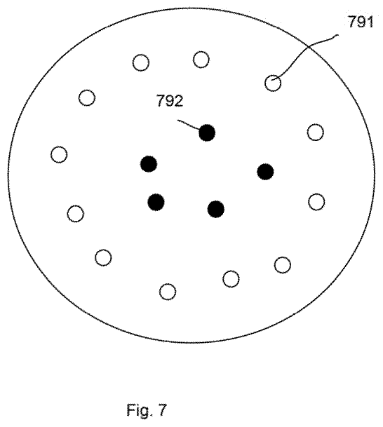

In FIG. 7, a number of white LED modules 791 surrounds color LED modules 792, like red, blue, green LED modules.

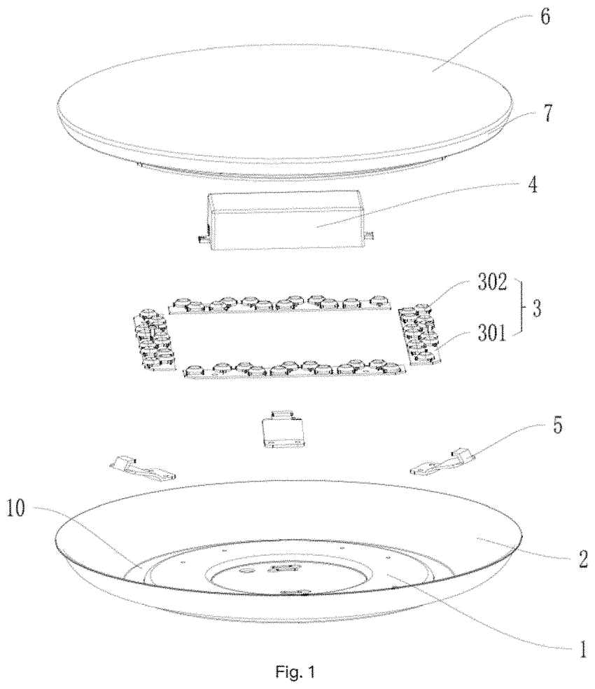

Please refer to FIG. 1, which illustrates a lighting apparatus example. In FIG. 1, a light passing cover 6 has a reverse edge 7 with sliding tracks to insert reverse hooks of hooks.

The light source module 3 has multiple LED strip that has a printed circuit board 301 mounted with LED modules 302. There are multiple hooks 5 fixed to an inner side of a base disk 1. The base disk 1 has a curved wall 2. There is a surrounding ring 10 for mounting the LED strips in a central part.

FIG. 2 shows components in the example of FIG. 1 with a side view.

In FIG. 2, there is a sliding groove 8 for inserting the hook 5 that has a fixed end fixed to the base disk 1.

FIG. 3 shows a connecting cover 7 with escape parts 9 for inserting the hook 5 to the sliding groove.

FIG. 4 shows a hook 5 example with a fixed end 501 and a reverse hook 502.

In some embodiments, the driver module has an ambient sensor for detecting an ambient color temperature when the LED strips are turned off and control the LED strips to mix a required mixed color temperature based on the ambient color temperature.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

1. A lighting apparatus, comprising:
a light passing cover having an exterior side and an inner side, wherein the inner side has multiple sliding grooves;
a base disk having a central part and a curved wall;
multiple hooks, wherein each hook has a fixed end and a reverse hook, the fixed end is fixed to the base disk, the reverse hook is inserted to the sidling groove to fix the light passing cover to the base disk;
a light source module mounted on the base disk, wherein the light source module includes multiple LED strips; and
a driver module disposed at a center of the base disk, wherein the driver module is surrounded by the multiple LED strips, the LED strips includes multiple LED modules, each LED module has a diffusion lens disposed on a LED chip for diffusing a light of the LED chip.

2. The lighting apparatus of claim 1, wherein the central part of the base disk has a concave area with fixing holes for fixing to an installation unit, an external wire is passes through the concave area connected to the driver module.

3. The lighting apparatus of claim 2, wherein the central part has a surrounding ring surrounding the concave area, the LED strips are fixed on the surrounding ring.

4. The lighting apparatus of claim 2, wherein the curve wall has a reflective layer facing to the LED module.

5. The lighting apparatus of claim 1, wherein the driver module has multiple sockets for electrically connected to the multiple LED strips.

6. The lighting apparatus of claim 5, wherein the driver module has an insulation box preventing electricity contact of a driver circuit from users.

7. The lighting apparatus of claim 6, wherein a reflective layer is attached on an exterior surface of the insulation box.

8. The lighting apparatus of claim 5, wherein the LED strip has an electrode end to be detachably plugged into the socket of the driver module.

9. The lighting apparatus of claim 8, wherein the driver module automatically adjusts a control mode depending on a number of inserted LED strips.

10. The lighting apparatus of claim 8, wherein the electrode end has a type structure for indicating the driver module which type of the inserted LED strip.

11. The lighting apparatus of claim 1, wherein the LED strip has a conductive part covered by an insulation layer.

12. The lighting apparatus of claim 1, wherein the light passing cover has an escape part at an entrance of the sliding groove for the reverse hook to slide into the sliding groove.

13. The lighting apparatus of claim 1, wherein the driver module is detachably plugged to a plugging terminal disposed on the central part of the base disk, users select a required type of the driver module to be plugged to the plugging terminal.

14. The lighting apparatus of claim 13, wherein the plugging terminal is electrically connected to an external power source.

15. The lighting apparatus of claim 13, wherein an antenna is fixed to a top surface of the driver module facing to the light passing cover.

16. The lighting apparatus of claim 13, wherein a top cover of the driver module facing to the light passing cover emits a second light.

17. The lighting apparatus of claim 16, wherein a switch is used for a user to adjust intensity of the second light to be consistent with a first light of the light source appearing on the light passing cover.

18. The lighting apparatus of claim 1, wherein the LED strips are mounted with red, green, blue LED modules and two white LED modules with different color temperatures.

19. The lighting apparatus of claim 18, wherein the red, green, blue LED modules are located at central areas surrounded by a portion of the white LED modules.

20. The lighting apparatus of claim 18, wherein the driver module has an ambient sensor for detecting an ambient color temperature when the LED strips are turned off and control the LED strips to mix a required mixed color temperature based on the ambient color temperature.
